(19) United States
(12) Patent Application Publication
(10) Pub. No.: US 2023/0419053 A1
(43) Pub. Date: Dec. 28, 2023

(54) Systems And Methods For Training Translation Models Using Source-Augmented Training Examples

(71) Applicant: Google LLC, Mountain View, CA (US)

(72) Inventors: Jing Huang, Sunnyvale, CA (US); Apurva Shah, Burlingame, CA (US); Melvin Johnson, Sunnyvale, CA (US); Viresh Ratnakar, Los Altos, CA (US); Maxim Krikun, Castro Valley, CA (US)

(21) Appl. No.: 17/988,315

(22) Filed: Nov. 16, 2022

Related U.S. Application Data
(63) Continuation of application No. PCT/US2022/035259, filed on Jun. 28, 2022.

(51) Int. Cl. G06F 40/58; G06F 40/51; G06F 40/49

(52) U.S. Cl. CPC G06F 40/58; G06F 40/51; G06F 40/49

(57) ABSTRACT

Systems and methods for training a translation model based on a first text sequence in a first language, a second text sequence in a second language different from the first language, and a label based on a source of the second text sequence. In some examples, the label may comprise an Internet domain, an Internet subdomain, a uniform resource locator, a website name, or an IP address. In some examples, the label may further indicate a source of the first text sequence. In some examples, each given training example may be automatically generated by sampling the first text sequence from a first page of a given Internet domain, sampling the second text sequence from a second page of the given Internet domain, and generating the label based on all or a portion of source data of the second page.

### CROSS-REFERENCE TO RELATED APPLICATIONS

The present application is a continuation of International Application No. PCT/US2022/035259, filed Jun. 28, 2022, the entire disclosure of which is hereby incorporated by reference.

### BACKGROUND

### Background

The quality of the translations produced by neural machine translation models may be impacted by both the amount and the quality of the data used to train the models. Unfortunately, while large amounts of training data may be collected using various automatic methods, ensuring the quality of such data may be difficult, often requiring human supervision. For example, systems may be configured to crawl the Internet to identify sets of pages published in multiple languages (e.g., a page from a domain en.website.com and es.website.com may have the same content published in English and Spanish, respectively) and isolate corresponding sequences of text from which training examples may be generated. However, training examples from some websites or webpages may be of relatively higher or lower quality depending on various factors, e.g., whether translations have been created or overseen by human translators, whether the translations are more succinct or more verbose, etc. Likewise, training examples from some websites or webpages may use a specific vernacular, making them more or less desirable for training a given translation model (e.g., webpages directed to certain regions may use region-specific dialects, webpages directed to scientific or legal content may use terms that have different meanings in non-scientific or non-legal contexts, etc.).

### BRIEF SUMMARY

The present technology concerns systems and methods for training translation models using source-augmented training examples such that the models may learn to associate particular translation styles with the source of each example. For example, in some aspects of the technology, a translation model may be trained based on a first text sequence in a first language, a second text sequence in a second language different from the first language, and a label based on a source of the second text sequence. In some aspects, the label may comprise an Internet domain, an Internet subdomain, a uniform resource locator (“URL”), a website name, or an IP address relating to the source of the second text sequence. Likewise, in some aspects, the label may further indicate a source of the first text sequence. Further, in some aspects of the technology, each given training example of the plurality of training examples may be automatically generated by sampling the first text sequence from a first page of a given Internet domain, sampling the second text sequence from a second page of the given Internet domain, and generating the label based on a source of the second text sequence and/or the first text sequence (e.g., all or a portion of a URL, Internet domain, Internet subdomain, website name, or IP address of the first and/or second page).

The present technology may thus produce translation models that can be prompted to emulate the translations of a particular high-quality or otherwise desirable source during inference by merely including that source's label with the input text sequence. These high-quality or desirable sources may be identified after training by repeatedly feeding a validation set of examples to the trained translation model using different labels and comparing the quality of the translations produced (e.g., using automatic quality metrics, human graders, or combinations thereof). In this way, the present technology may reduce or eliminate the amount of filtering needed for a given set of training data, thus enabling translation models to be trained using large data sets of synthetic training examples that were automatically collected, generated, and/or filtered. Likewise, the present technology may be used to generate translation models that can be flexibly and efficiently “tuned” to emulate different translation qualities and/or styles by simply changing which source labels are used during inference. The present technology can thus solve the technical problem of how to control the output of a translation model that is trained on multiple sources or domains so as to generate a translation based on the characteristics of a particular source or domain of interest. Moreover, in various example implementations, this may be achieved by training only a single model (rather than one or more models per domain of interest), thus reducing technical complexity and computational cost.

In one aspect, the disclosure describes a computer-implemented method, comprising training a translation model, wherein the training comprises: (1) for each given training example of a plurality of training examples, the given training example including a first text sequence in a first language, a second text sequence in a second language different from the first language, and a label based on a source of the second text sequence: generating, using the translation model, a predicted text sequence based at least in part on the first text sequence and the label of the given training example; and comparing, using one or more processors of a processing system, the predicted text sequence to the second text sequence to generate a loss value for the given training example; and (2) modifying, using the one or more processors, one or more parameters of the translation model based at least in part on the loss values generated for each of the plurality of training examples. In some aspects, the label comprises an Internet domain. In some aspects, the label comprises an Internet subdomain. In some aspects, the label comprises a uniform resource locator. In some aspects, the label comprises a website name. In some aspects, the label comprises an IP address. In some aspects, the label further indicates a source of the first text sequence. In some aspects, a source of the first text sequence is in a first subdomain of a given Internet domain, and the source of the second text sequence is in a second subdomain of the given Internet domain. In some aspects, the method further comprises generating, using the one or more processor, each given training example of the plurality of training examples by: sampling the first text sequence from a first page of a given Internet domain; sampling the second text sequence from a second page of the given Internet domain; and generating the label based on all or a portion of a uniform resource locator of the second page. In some aspects, the method further comprises generating, using the one or more processor, each given training example of the plurality of training examples by: sampling the first text sequence from a first page of a given Internet domain; sampling the second text sequence from a second page of the given Internet domain; and generating the label based on all or a portion of an IP address of the second page.

In another aspect, the disclosure describes a computer program product comprising computer readable instructions that, when executed by a processing system, cause the processing system to perform any of the methods described in the preceding paragraph.

In another aspect, the disclosure describes a processing system comprising: (1) a memory storing a translation model; and (2) one or more processors coupled to the memory and configured to train the translation model according to a training method comprising: (a) for each given training example of a plurality of training examples, the given training example including a first text sequence in a first language, a second text sequence in a second language different from the first language, and a label based on a source of the second text sequence: generating, using the translation model, a predicted text sequence based at least in part on the first text sequence and the label of the given training example; and comparing the predicted text sequence to the second text sequence to generate a loss value for the given training example; and (b) modifying one or more parameters of the translation model based at least in part on the loss values generated for each of the plurality of training examples. In some aspects, the one or more processors are configured to train the translation model according to the training method with each given training example including a label that comprises an Internet domain. In some aspects, the one or more processors are configured to train the translation model according to the training method with each given training example including a label that comprises an Internet subdomain. In some aspects, the one or more processors are configured to train the translation model according to the training method with each given training example including a label that comprises a uniform resource locator. In some aspects, the one or more processors are configured to train the translation model according to the training method with each given training example including a label that comprises a website name. In some aspects, the one or more processors are configured to train the translation model according to the training method with each given training example including a label that comprises an IP address. In some aspects, the one or more processors are configured to train the translation model according to the training method with each given training example including a label that indicates a source of first text sequence and the source of the second text sequence. In some aspects, the one or more processors are further configured to generate each given training example of the plurality of training examples by: sampling the first text sequence from a first page of a given Internet domain; sampling the second text sequence from a second page of the given Internet domain; and generating the label based on all or a portion of a uniform resource locator of the second page. In some aspects, the one or more processors are further configured to generate each given training example of the plurality of training examples by: sampling the first text sequence from a first page of a given Internet domain; sampling the second text sequence from a second page of the given Internet domain; and generating the label based on all or a portion of an IP address of the second page.

In another aspect, the disclosure describes a processing system comprising: (1) a memory storing a translation model; and (2) one or more processors coupled to the memory and configured to use the translation model to generate a predicted translation of an input text sequence based on the input text sequence and a label, wherein the translation model has been trained to generate the predicted translation pursuant to a training method comprising: (a) for each given training example of a plurality of training examples, the given training example including a first text sequence in a first language, a second text sequence in a second language different from the first language, and a label based on a source of the second text sequence: generating, using the translation model, a predicted text sequence based at least in part on the first text sequence and the label of the given training example; and comparing the predicted text sequence to the second text sequence to generate a loss value for the given training example; and (b) modifying one or more parameters of the translation model based at least in part on the loss values generated for each of the plurality of training examples.

### BRIEF DESCRIPTION OF THE DRAWINGS

FIG. 1 is a functional diagram of an example system in accordance with aspects of the disclosure.

FIG. 2 is a functional diagram of an example system in accordance with aspects of the disclosure.

FIG. 3 is a flow diagram illustrating how an exemplary training example may be generated based on pages of a website, in accordance with aspects of the disclosure.

FIG. 4 sets forth an exemplary method for training a translation model, in accordance with aspects of the disclosure.

FIG. 5 sets forth an exemplary method for generating a plurality of training examples, in accordance with aspects of the disclosure.

### DETAILED DESCRIPTION

The present technology will now be described with respect to the following exemplary systems and methods. Reference numbers in common between the figures depicted and described below are meant to identify the same features.

### Example Systems

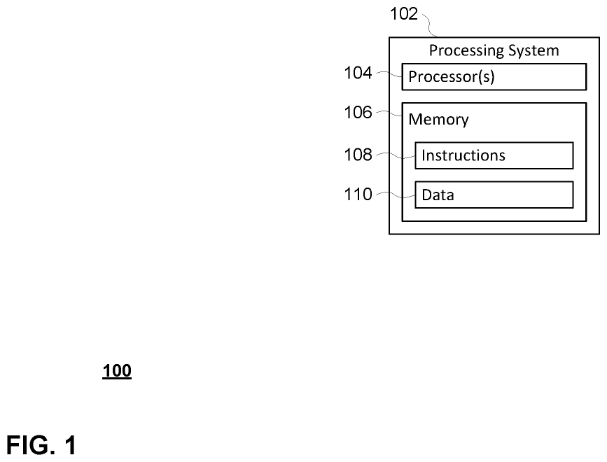

FIG. 1 shows a high-level system diagram 100 of an exemplary processing system 102 for performing the methods described herein. The processing system 102 may include one or more processors 104 and memory 106 storing instructions 108 and data 110. The instructions 108 and data 110 may include a translation model, as described further below. In addition, the data 110 may store training examples to be used in training the translation model (e.g., those used in pre-training, training, or fine-tuning), training signals and/or loss values generated during training, and/or predicted text sequences generated by the translation model.

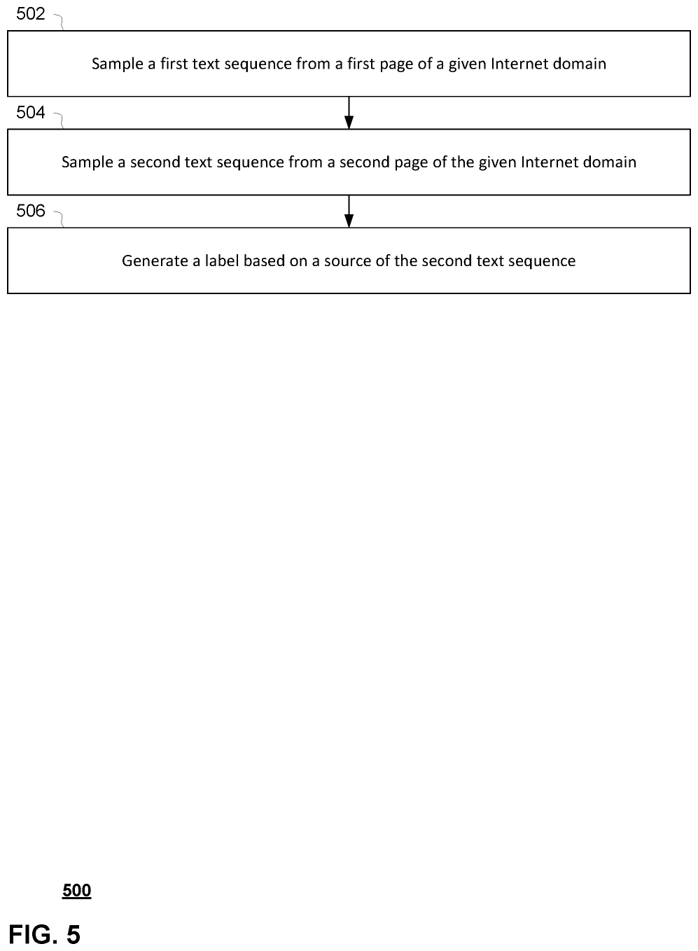

Processing system 102 may be resident on a single computing device. For example, processing system 102 may be a server, personal computer, or mobile device, and the translation model may thus be local to that single computing device. Similarly, processing system 102 may be resident on a cloud computing system or other distributed system. In such a case, the translation model may be distributed across two or more different physical computing devices. For example, the processing system may comprise a first computing device storing layers 1-n of a translation model having m layers, and a second computing device storing layers n-m of the translation model. In such cases, the first computing device may be one with less memory and/or processing power (e.g., a personal computer, mobile phone, tablet, etc.) compared to that of the second computing device, or vice versa. Likewise, in some aspects of the technology, the processing system may comprise one or more computing devices storing the translation model, and one or more separate computing devices configured to collect and/or generate training examples (e.g., as discussed further below with respect to the exemplary method 500 of FIG. 5). Further, in some aspects of the technology, data used by the translation model (e.g., training data, labels used during inference, etc.) may be stored on a different computing device than the translation model.

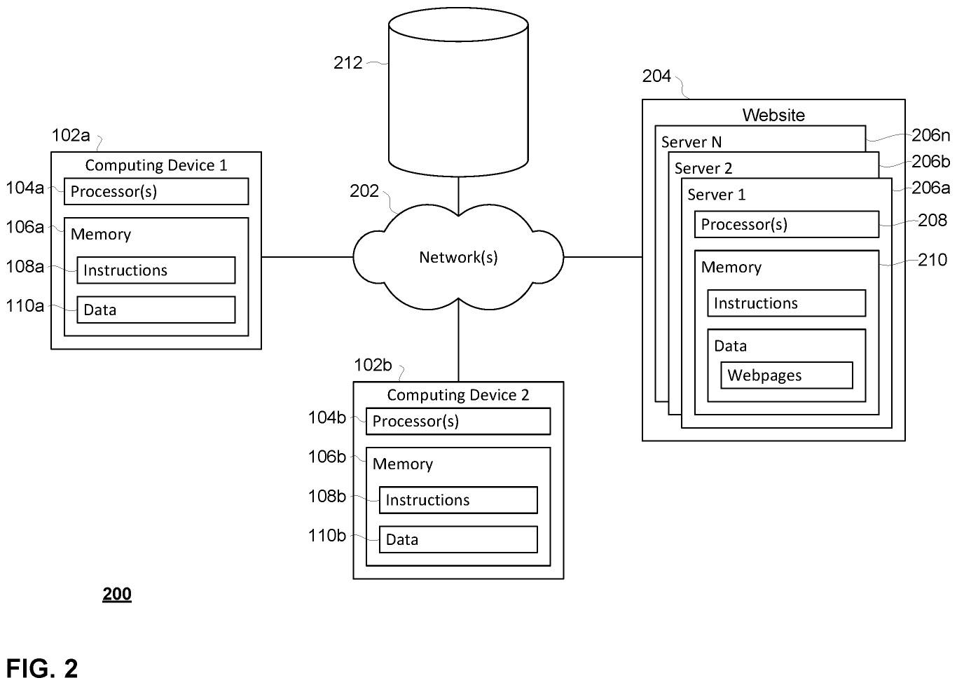

Further in this regard, FIG. 2 shows a high-level system diagram 200 in which the exemplary processing system 102 just described is distributed across two computing devices 102a and 102b, each of which may include one or more processors (104a, 104b) and memory (106a, 106b) storing instructions (108a, 108b) and data (110a, 110b). The processing system 102 comprising computing devices 102a and 102b is shown being in communication with one or more websites and/or remote storage systems over one or more networks 202, including website 204 and remote storage system 212. In this example, website 204 includes one or more servers 206a-206n. Each of the servers 206a-206n may have one or more processors (e.g., 208), and associated memory (e.g., 210) storing instructions and data, including the content of one or more webpages. Likewise, although not shown, remote storage system 212 may also include one or more processors and memory storing instructions and data. In some aspects of the technology, the processing system 102 comprising computing devices 102a and 102b may be configured to retrieve data from one or more of website 204 and/or remote storage system 212, for use in training the translation model. For example, in some aspects, the first computing device 102a may be configured to retrieve training examples from the remote storage system 212 for use in pre-training, training, or fine-tuning of a translation model housed on the first computing device 102a and/or the second computing device 102b. Likewise, in some aspects, the first computing device 102a may be configured to store the translation model, while the second computing device 102b may be configured to collect data from website 204 and generate training examples based on the retrieved data for use in training the translation model (e.g., as discussed further below with respect to the exemplary method 500 of FIG. 5). Further, in such cases, the second computing device 102b may be configured to store one or more of the generated training examples on the remote store system 212, for retrieval by the first computing device 102a.

The processing systems described herein may be implemented on any type of computing device(s), such as any type of general computing device, server, or set thereof, and may further include other components typically present in general purpose computing devices or servers. Likewise, the memory of such processing systems may be of any non-transitory type capable of storing information accessible by the processor(s) of the processing systems. For instance, the memory may include a non-transitory medium such as a hard-drive, memory card, optical disk, solid-state, tape memory, or the like. Computing devices suitable for the roles described herein may include different combinations of the foregoing, whereby different portions of the instructions and data are stored on different types of media.

In all cases, the computing devices described herein may further include any other components normally used in connection with a computing device such as a user interface subsystem. The user interface subsystem may include one or more user inputs (e.g., a mouse, keyboard, stylus, touch screen, and/or microphone) and one or more electronic displays (e.g., a monitor having a screen or any other electrical device that is operable to display information). Output devices besides an electronic display, such as speakers, lights, and vibrating, pulsing, or haptic elements, may also be included in the computing devices described herein.

The one or more processors included in each computing device may be any conventional processors, such as commercially available central processing units (“CPUs”), graphics processing units (“GPUs”), tensor processing units (“TPUs”), etc. Alternatively, the one or more processors may be a dedicated device such as an ASIC or other hardware-based processor. Each processor may have multiple cores that are able to operate in parallel. The processor(s), memory, and other elements of a single computing device may be stored within a single physical housing, or may be distributed between two or more housings. Similarly, the memory of a computing device may include a hard drive or other storage media located in a housing different from that of the processor(s), such as in an external database or networked storage device. Accordingly, references to a processor or computing device will be understood to include references to a collection of processors or computing devices or memories that may or may not operate in parallel, as well as one or more servers of a load-balanced server farm or cloud-based system.

The computing devices described herein may store instructions capable of being executed directly (such as machine code) or indirectly (such as scripts) by the processor(s). The computing devices may also store data, which may be retrieved, stored, or modified by one or more processors in accordance with the instructions. Instructions may be stored as computing device code on a computing device-readable medium. In that regard, the terms “instructions” and “programs” may be used interchangeably herein. Instructions may also be stored in object code format for direct processing by the processor(s), or in any other computing device language including scripts or collections of independent source code modules that are interpreted on demand or compiled in advance. By way of example, the programming language may be C#, C++, JAVA or another computer programming language. Similarly, any components of the instructions or programs may be implemented in a computer scripting language, such as JavaScript, PHP, ASP, or any other computer scripting language. Furthermore, any one of these components may be implemented using a combination of computer programming languages and computer scripting languages.

### Example Methods

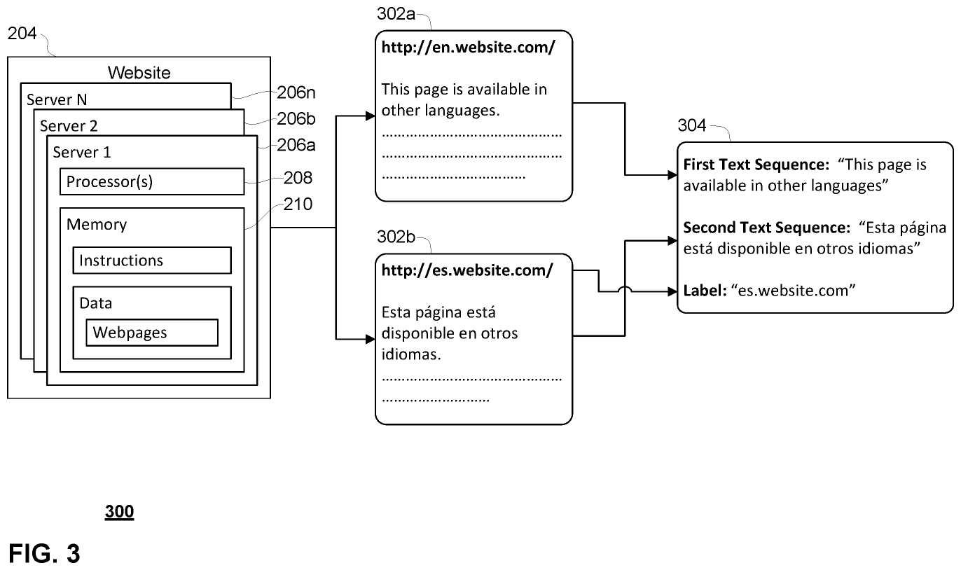

FIG. 3 is a flow diagram 300 illustrating how an exemplary training example may be generated based on pages of a website, in accordance with aspects of the disclosure. In the example of FIG. 3, it is assumed that the website in question is the exemplary website 204 of FIG. 2, described above. It is further assumed that website 204 includes two webpages 302a and 302b. In this example, webpage 302a is from URL “http://en.website.com/” and includes text in English, while webpage 302b is from URL “http://es.website.com/” and includes corresponding text in Spanish. Thus, webpages 302a and 302b are from different subdomains of the same root domain (website.com).

FIG. 3 further shows a training example 304 that may be generated from the content of webpages 302a and 302b. In this case, training example 304 includes a first text sequence comprising a sentence from webpage 302a stating in English “This page is available in other languages,” a second text sequence comprising the corresponding sentence from webpage 302b stating in Spanish “Esta pagina esta disponible en otros idiomas,” and a label comprising a portion of the URL of webpage 302b. As will be appreciated, it would also be possible to generate a second training example in which the sentence from webpage 302b is the “first text sequence,” the sentence from webpage 302a is the “second text sequence,” and the label comprises a portion of the URL of webpage 302a.

Although the label in the example of FIG. 3 uses the full domain name of webpage 302b, the label may be based on any suitable information regarding the source of webpage 302b. For example, in some aspects, the label of training example 304 may include the full URL of webpage 302b (e.g., http://es.website.com/), a domain and/or subdomain of webpage 302b (e.g., “es.website.com,” “website.com,” “es,” “website,” or “com”), the name of the website (e.g., “Website”), the IP address of the webpage 302b, and/or any other suitable information relating to the source of webpage 302b.

Likewise, although not reflected in the example of FIG. 3, in some aspects of the technology, the label may include information regarding the source of the first text sequence in lieu of or in addition to information based on a source of the second text sequence. For example, in some aspects, the label of training example 304 may include information regarding the source of webpage 302a, such as the full URL of webpage 302a (e.g., http://en.website.com/), a domain and/or subdomain of webpage 302a (e.g., “en.website.com,” “website.com,” “en,” “website,” or “com”), the name of the website (e.g., “Website”), the IP address of the webpage 302a, and/or any other suitable information relating to the source of webpage 302a.

Further, in some aspects, the label of training example 304 may include information that is not directly related to the source of webpages 302a and 302b. For example, where webpages 302a and 302b were obtained from a website or curated set of webpages that relate to a particular topic (e.g., artificial intelligence, law, sports, etc.), the label of training example 304 may comprise (either alone, or in addition to other source information) information relating to that topic.

The label may be included in the training example 304 in any suitable way and formatting. For example, in some aspects of the technology, the label may be prepended or appended to the input sequence as a vector embedding, tokenized text, or raw text (thus requiring no extra preprocessing or special vocabulary). In that regard, where training examples have been collected from sources with similar domain names, including the raw text of the domain names in each label may increase the likelihood of the translation model inferring similarities between the training examples of those domains.

Although the example of FIG. 3 assumes that the training example 304 will be generated based on text collected from webpages 302a and 302b, it will be understood that training examples may be generated from any suitable source available in more than one language (e.g., books, user manuals, advertisements, song lyrics, etc.). Thus, as an example, a training example may be generated from a first text sequence collected from a book, and a second corresponding text sequence collected from a translated copy of the book, with a label indicating information based on the source such as the title of the book, the title of the translated copy, the name of the author, the name of the translator, etc.

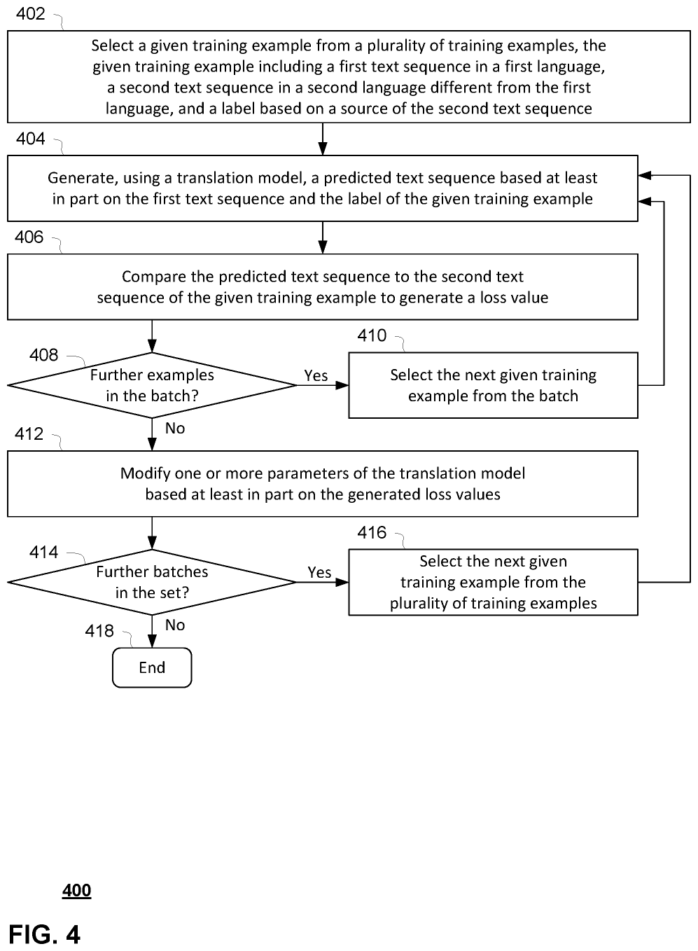

FIG. 4 sets forth an exemplary method 400 for training a translation model, in accordance with aspects of the disclosure.

In step 402, a processing system (e.g., processing system 102 of FIG. 1 or 2) selects a given training example from a plurality of training examples, the given training example including a first text sequence in a first language, a second text sequence in a second language different from the first language, and a label based on a source of the second text sequence. The plurality of training examples may be from any suitable source or collection of sources. For example, the plurality of training examples may include training examples from existing databases of training data, human-generated or human-supervised examples, and/or synthetically generated examples (e.g., generated according to the exemplary method 500 of FIG. 5). The labels may also include any suitable information regarding the source of the second text sequence, including any of the options discussed above with respect to training example 304 of FIG. 3.

In addition, although not reflected in the example of FIG. 4, in some aspects of the technology, the label may include other information in lieu of or in addition to information based on a source of the second text sequence, as also discussed above with respect to training example 304 of FIG. 3. In that regard, in some aspects, the label may include information regarding the source of the first text sequence in lieu of or in addition to information based on a source of the second text sequence. Likewise, in some aspects, the label may include information that is not directly related to the source of the first text sequence or the second text sequence (e.g., a topical area or group to which the training example belongs) in lieu of or in addition to information based on a source of the second text sequence.

In step 404, the processing system uses a translation model to generate a predicted text sequence based at least in part on the first text sequence and the label of the given training example (e.g., the first text sequence and label of training example 304 of FIG. 3). The processing system may do this using a translation model of any suitable type, architecture, and number of parameters, including those based on Transformer architectures, Long Short-Term Memory (“LSTM”) architectures, Recurrent Neural Network architectures (“RNN”), Convolutional Neural Network (“CNN”) architectures, and/or any suitable hybrids thereof. For example, in some aspects of the technology, the translation model may be a deep LSTM network with multiple encoder and decoder layers (e.g., a 6-layer LSTM encoder and an 8-layer LSTM decoder, an 8-layer LSTM encoder and an 8-layer LSTM decoder, etc.). Likewise, in some aspects of the technology, the translation model may be based on a hybrid architecture such as one using a transformer as the encoder and an RNN as the decoder (e.g., a 12-layer transformer encoder and a 2-layer RNN decoder).

Further, the translation model may generate the predicted text sequence based directly or indirectly on the first text sequence and the label of the given training example. Thus, for example, the processing system or translation model may be configured to initially process the first text sequence and/or the label to generate modified versions thereof (e.g., tokenized versions of the first text sequence and/or the label, vectors based on the first text sequence and/or the label, etc.). In such cases, the translation model may generate the predicted text sequence based on the modified versions of the first text sequence and/or the label (e.g., the tokenized versions, vectors, etc.).

In step 406, the processing system compares the predicted text sequence to the second text sequence of the given training example (e.g., the second text sequence of training example 304 of FIG. 3) to generate a loss value. The processing system may make this comparison and generate a loss value in any suitable way, using any suitable loss function(s). For example, in some aspects of the technology, the processing system may be configured to compare the predicted text sequence to the second text sequence using a “hard distillation” method that assess how similar each string of text is to the other. Likewise, in some aspects, the processing system may be configured to compare the predicted text sequence to the second text sequence using a connectionist temporal classification loss (“CTC loss”) or a cross-entropy loss.

In step 408, the processing system determines if there are further training examples in the batch. In that regard, the plurality of training examples may be broken into multiple batches, or kept whole, in which case there will be one single “batch” containing every training example of the plurality of first training examples. In either case, as shown by the “yes” arrow, if the processing system determines that there are further training examples in the batch, it will proceed to step 410. In step 410, the processing system will select the next given training example from the batch, and then repeat steps 404-408 for that newly selected training example. This process will then be repeated for each next given training example of the batch until the processing system determines, at step 408, that there are no further training examples in the batch, and thus proceeds to step 412 (as shown by the “no” arrow).

As shown in step 412, after a loss value has been generated (in step 406) for every given training example in the batch, the processing system modifies one or more parameters of the translation model based at least in part on the generated loss values. The processing system may be configured to modify the one or more parameters based on these generated loss values in any suitable way and at any suitable interval. For example, an optimization routine, such as stochastic gradient descent, may be applied to the generated loss values to determine parameter modifications. In some aspects of the technology, each “batch” may include a single training example such that the processing system will conduct a back-propagation step in which it modifies the one or more parameters of the translation model every time a loss value is generated. Likewise, where each “batch” includes two or more training examples, the processing system may be configured to combine the generated loss values into an aggregate loss value (e.g., by summing or averaging the multiple loss values), and modify the one or more parameters of the translation model based on that aggregate loss value.

In step 414, the processing system determines if there are further batches in the plurality of training examples. Where the plurality of training examples has not been broken up, and there is thus one single “batch” containing every training example in the plurality of training examples, the determination in step 414 will automatically be “no,” and method 400 will then end as shown in step 418. However, where the plurality of training examples has been broken into two or more batches, the processing system will follow the “yes” arrow to step 416 to select the next given training example from the plurality of training examples. This will then start another set of passes through steps 404-408 for each training example in the next batch and another modification of one or more parameters of the translation model in step 412. This process will continue until there are no further batches remaining, at which point the processing system will follow the “no” arrow to step 418.

Although method 400 is shown as ending in step 418 once all training examples of the plurality of training examples have been used to tune the parameters of the translation model, it will be understood that method 400 may be repeated any suitable number of times using the same plurality of training examples until each of its predicted text sequences are sufficiently close to their respective second text sequences in each training example. In that regard, in some aspects of the technology, the processing system may be configured to repeat method 400 for the plurality of training examples some predetermined number of times. Further, in some aspects, the processing system may be configured to aggregate all of the loss values generated during a given pass through method 400, and determine whether to repeat method 400 for the plurality of training examples based on that aggregate loss value. For example, in some aspects of the technology, the processing system may be configured to repeat method 400 for the plurality of training examples if the aggregate loss value for the most recent pass through method 400 was greater than some predetermined threshold. Likewise, in some aspects, the processing system may be configured to use gradient descent, and to thus repeat method 400 for the plurality of training examples until the aggregate loss value on a given pass through method 400 is equal to or greater than the aggregate loss value from the pass before it.

As noted above, once the translation model has been trained according to method 400, it may be tested using different labels to determine which labels cause the trained translation model to produce the highest-quality results for a given validation set. For example, if the trained translation model is intended to be used to translate between English and French, a validation set may be obtained for that language pairing (e.g., from a benchmark translation data set, from one or more representative websites or books, etc.). Likewise, if the trained translation model is intended to perform translations in a certain topical area, a validation set may be obtained from sources in that topical area (e.g., websites concerning that topic, books concerning that topic, etc.). The examples of the validation set may then be repeatedly fed to the translation model to generate translations using each different label in a set of candidate labels. The translation sets for each candidate label may then be assessed for quality, and compared in order to identify which labels caused the translation model to produce the most desirable results. These quality assessments may be made in any suitable way, such as using any known automatic quality metrics (e.g., BLEU, BLEURT, ROUGE, BERTscore), comparisons to target translations (e.g., if using examples from a benchmark training set that includes a target translation for each input text sequence), assessments by human graders, or combinations thereof.

FIG. 5 sets forth an exemplary method 500 for generating a plurality of training examples, in accordance with aspects of the disclosure. In that regard, in some aspects of the technology, the exemplary method of FIG. 5 may be used to generate the plurality of training examples referenced in method 400 of FIG. 4.

In step 502, a processing system (e.g., processing system 102 of FIG. 1 or 2, the processing system of method 400 of FIG. 4, etc.) samples a first text sequence from a first page of a given Internet domain (e.g., the first text sequence sampled from webpage 302a to generate training example 304 of FIG. 3). The processing system may perform this sampling in any suitable way. For example, in some aspects of the technology, the processing system may sample the first text sequence directly from the first page. Likewise, in some aspects, the processing system may download the first page (or a portion thereof), and may then sample the first text sequence from that downloaded copy or portion of the first page.

In step 504, the processing system samples a second text sequence from a second page of the given Internet domain (e.g., the second text sequence sampled from webpage 302b to generate training example 304 of FIG. 3). Here as well, the processing system may perform this sampling in any suitable way. For example, in some aspects of the technology, the processing system may sample the second text sequence directly from the second page. Likewise, in some aspects, the processing system may download the second page (or a portion thereof), and may then sample the second text sequence from that downloaded copy or portion of the second page.

In step 506, the processing system generates a label based on a source of the second text sequence (e.g., the label generated based on the URL of webpage 302b to generate training example 304 of FIG. 3). As discussed above with respect to training example 304 of FIG. 3, the processing system may generate a label based on any suitable information regarding the source of the second text sequence, including any of the options discussed above with respect to training example 304 of FIG. 3. Thus, in some aspects of the technology, the processing system may generate a label based on all or a portion of: a URL of the second page (e.g., “http://es.website.com/,” “es.website.com,” “website.com,” “es,” “website,” or “com”), the name of the website (e.g., “Website”), the IP address of the second page, and/or any other suitable information relating to the source of the second page.

In addition, although not reflected in the example of FIG. 5, in some aspects of the technology, the label may include other information in lieu of or in addition to information based on a source of the second text sequence, as also discussed above with respect to training example 304 of FIG. 3. In that regard, in some aspects, the label may include information regarding the source of the first text sequence in lieu of or in addition to information based on a source of the second text sequence. For example, the label may include all or a portion of: a URL of the first page (e.g., “http://en.website.com/,” “en.website.com,” “website.com,” “es,” “website,” or “com”), the name of the website (e.g., “Website”), the IP address of the second page, and/or any other suitable information relating to the source of the first page. Likewise, in some aspects, the label may include information that is not directly related to the source of the first text sequence or the second text sequence (e.g., a topical area or group to which the training example belongs) in lieu of or in addition to information based on a source of the second text sequence.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of exemplary systems and methods should be taken by way of illustration rather than by way of limitation of the subject matter defined by the claims. In addition, the provision of the examples described herein, as well as clauses phrased as “such as,” “including,” “comprising,” and the like, should not be interpreted as limiting the subject matter of the claims to the specific examples; rather, the examples are intended to illustrate only some of the many possible embodiments. Further, the same reference numbers in different drawings can identify the same or similar elements.

1. A computer-implemented method, comprising:
training a translation model, wherein the training comprises:
for each given training example of a plurality of training examples, the given training example including a first text sequence in a first language, a second text sequence in a second language different from the first language, and a label based on a source of the second text sequence:
generating, using the translation model, a predicted text sequence based at least in part on the first text sequence and the label of the given training example; and
comparing, using one or more processors of a processing system, the predicted text sequence to the second text sequence to generate a loss value for the given training example; and
modifying, using the one or more processors, one or more parameters of the translation model based at least in part on the loss values generated for each of the plurality of training examples.

2. The method of claim 1, wherein the label comprises an Internet domain.

3. The method of claim 1, wherein the label comprises an Internet subdomain.

4. The method of claim 1, wherein the label comprises a uniform resource locator.

5. The method of claim 1, wherein the label comprises a website name.

6. The method of claim 1, wherein the label comprises an IP address.

7. The method of claim 1, wherein the label further indicates a source of the first text sequence.

8. The method of claim 1, wherein a source of the first text sequence is in a first subdomain of a given Internet domain, and the source of the second text sequence is in a second subdomain of the given Internet domain.

9. The method of claim 1, further comprising:
generating, using the one or more processor, each given training example of the plurality of training examples by:
sampling the first text sequence from a first page of a given Internet domain;
sampling the second text sequence from a second page of the given Internet domain; and
generating the label based on all or a portion of a uniform resource locator of the second page.

10. The method of claim 1, further comprising:
generating, using the one or more processor, each given training example of the plurality of training examples by:
sampling the first text sequence from a first page of a given Internet domain;
sampling the second text sequence from a second page of the given Internet domain; and
generating the label based on all or a portion of an IP address of the second page.

11. A processing system comprising:
a memory storing a translation model; and
one or more processors coupled to the memory and configured to train the translation model according to a training method comprising:
for each given training example of a plurality of training examples, the given training example including a first text sequence in a first language, a second text sequence in a second language different from the first language, and a label based on a source of the second text sequence:
generating, using the translation model, a predicted text sequence based at least in part on the first text sequence and the label of the given training example; and
comparing the predicted text sequence to the second text sequence to generate a loss value for the given training example; and
modifying one or more parameters of the translation model based at least in part on the loss values generated for each of the plurality of training examples.

12. The processing system of claim 11, wherein the one or more processors are configured to train the translation model according to the training method with each given training example including a label that comprises an Internet domain.

13. The processing system of claim 11, wherein the one or more processors are configured to train the translation model according to the training method with each given training example including a label that comprises an Internet subdomain.

14. The processing system of claim 11, wherein the one or more processors are configured to train the translation model according to the training method with each given training example including a label that comprises a uniform resource locator.

15. The processing system of claim 11, wherein the one or more processors are configured to train the translation model according to the training method with each given training example including a label that comprises a website name.

16. The processing system of claim 11, wherein the one or more processors are configured to train the translation model according to the training method with each given training example including a label that comprises an IP address.

17. The processing system of claim 11, wherein the one or more processors are configured to train the translation model according to the training method with each given training example including a label that indicates a source of first text sequence and the source of the second text sequence.

18. The processing system of claim 11, wherein the one or more processors are further configured to generate each given training example of the plurality of training examples by:
sampling the first text sequence from a first page of a given Internet domain;
sampling the second text sequence from a second page of the given Internet domain; and
generating the label based on all or a portion of a uniform resource locator of the second page.

19. The processing system of claim 11, wherein the one or more processors are further configured to generate each given training example of the plurality of training examples by:
sampling the first text sequence from a first page of a given Internet domain;
sampling the second text sequence from a second page of the given Internet domain; and
generating the label based on all or a portion of an IP address of the second page.

20. A processing system comprising:
a memory storing a translation model; and
one or more processors coupled to the memory and configured to use the translation model to generate a predicted translation of an input text sequence based on the input text sequence and a label,
wherein the translation model has been trained to generate the predicted translation pursuant to a training method comprising:
for each given training example of a plurality of training examples, the given training example including a first text sequence in a first language, a second text sequence in a second language different from the first language, and a label based on a source of the second text sequence:
generating, using the translation model, a predicted text sequence based at least in part on the first text sequence and the label of the given training example; and
comparing the predicted text sequence to the second text sequence to generate a loss value for the given training example; and
modifying one or more parameters of the translation model based at least in part on the loss values generated for each of the plurality of training examples.

21. A non-transitory computer readable medium comprising instructions which, when executed, cause one or more processors to perform a method comprising:
training a translation model, wherein the training comprises:
for each given training example of a plurality of training examples, the given training example including a first text sequence in a first language, a second text sequence in a second language different from the first language, and a label based on a source of the second text sequence:
generating, using the translation model, a predicted text sequence based at least in part on the first text sequence and the label of the given training example; and
comparing, using the one or more processors, the predicted text sequence to the second text sequence to generate a loss value for the given training example; and
modifying, using the one or more processors, one or more parameters of the translation model based at least in part on the loss values generated for each of the plurality of training examples.
